(19) United States
(12) Patent Application Publication
(10) Pub. No.: US 2002/0194703 A1
(43) Pub. Date: Dec. 26, 2002

(54) Adjustable hinge

(75) Inventors: David R. Cress, Janesville, WI (US); Michael J. Bowers, Rockford, IL (US); Thomas E. Martenson, Rockton, IL (US)

Correspondence Address: THOMAS A. MILLER, MARSHALL ,GERSTEIN & BORUN, 6300 SEARS TOWER, 233 SOUTH WACKER DRIVE, CHICAGO, IL, 60606-6357, US

(73) Assignee: Newell Operating Company

(21) Appl. No.: 09/886,744

(22) Filed: Jun. 21, 2001

(51) Int. Cl. E05D 7/04

(52) U.S. Cl. 16/260

(57) ABSTRACT

A hinge is disclosed including a door wing, and a frame wing pivotally coupled to the door wing having an aperture disposed in the frame wing. The aperture has an opening disposed on a first edge of the frame wing configured to allow a shaft of a fastener to slidably fit in the opening and then into the aperture. The frame wing may be adjusted in at least two directions with respect to a frame by moving the frame wing with respect to the fastener, such that the adjustment is bounded by the shaft of the fastener within the aperture.

### FIELD OF THE INVENTION

The present invention relates to hinges. Specifically, the present invention relates to adjustable hinges for use in applications such as doors and cabinets.

### BACKGROUND OF THE INVENTION

It is generally known to provide a hinge for mounting a door to a frame. For example, hinges are often used for mounting and coupling cabinet doors to cabinet frames. In order to increase assembling ease and efficiency when mounting cabinet doors to cabinet frames, it may be desirable to preinstall the hinge to the door. Once the hinge is mounted on the door, the door and hinge assembly may then be mounted to the frame. It may also be advantageous to preinstall fasteners to the frame prior to mounting the hinge to the frame. For example, it may be more efficient or more accurate to have the fastener preinstalled on the frame prior to mounting the hinge.

Preinstalled hinges may need to be adjusted to alter the placement and orientation of the door with respect to the frame for reasons such as assembling inaccuracies, tooling errors, etc.

It would be advantageous to provide a hinge which would allow the use of a preinstalled fastener in the frame. Furthermore, it would be advantageous to provide a hinge which would allow for adjustment in placement and orientation of the door with respect to the frame.

Accordingly, it would be desirable to provide a hinge which provides one or more of these advantageous features. The techniques below extend to those embodiments which fall within the scope of the appended claims, regardless of whether they provide one or more of the above-mentioned advantageous features.

### SUMMARY OF THE INVENTION

The present invention relates to a hinge including a door wing, and a frame wing pivotally coupled to the door wing having an aperture disposed in the frame wing. The aperture has an opening disposed on a first edge of the frame wing configured to allow a shaft of a fastener to slidably fit in the opening and into the aperture. The frame wing may be adjusted in at least two directions with respect to a frame by moving the frame wing with respect to the fastener, such that the adjustment is bounded by the shaft of the fastener within the aperture.

The present invention further relates to a frame wing configured to be pivotally coupled to a hinge wing. The frame wing includes a plate having an aperture disposed in the plate, an opening disposed on a first edge of the plate extending from the aperture. The opening is configured to slidably fit a fastener. The frame wing may be adjusted with respect to a frame by moving the frame wing with respect to the fastener, such that the adjustment is bounded by the shaft of the fastener within the aperture.

The present invention further relates to a method of adjustably mounting a door to a frame, the method including coupling a door wing to the door, and rotatably coupling a frame wing to the door wing. The method further includes partially securing a fastener to the frame, and coupling the frame wing to the frame. The method further includes passing the frame wing into a fastener through an opening, adjusting the position of the frame wing within the opening, and securing the fastener.

The present invention further relates to a hinge for coupling a door to a cabinet frame having a preinstalled fastener with a shaft and a head. The hinge includes a door wing pivotally coupled to a frame wing, the frame wing having a hinge arm portion and a mounting portion. The mounting portion includes an adjustment aperture, such that the adjustment aperture has a width, greater than the diameter of the shaft of the fastener, in at least two perpendicular directions. The adjustment aperture has an entry opening at least the width of the shaft of the fastener and extending between the adjustment aperture and an edge of the mounting portion.

### BRIEF DESCRIPTION OF THE DRAWINGS

FIG. 1 is a perspective view of a hinge coupled to a frame and a door according to an exemplary embodiment.

FIG. 2 is an exploded perspective view of the hinge shown in FIG. 1 coupled to a door and depicting a fastener coupled to a frame.

FIG. 3 is a cross-sectional view of the hinge taken along the line 3-3 of FIG. 1.

FIG. 4 is a top sectional view of the hinge taken along the line 4-4 of FIG. 3, depicting a first adjustment position.

FIG. 5 is a top sectional view of the hinge taken along the line 4-4 of FIG. 3, depicting a second adjustment position.

FIG. 6 is a top sectional view of the hinge taken along the line 4-4 of FIG. 3, depicting a third adjustment position.

FIG. 7 is a top sectional view of the hinge taken along the line 4-4 of FIG. 3, depicting a fourth adjustment position.

FIG. 8 is a top sectional view of the hinge taken along the line 4-4 of FIG. 3, depicting a fifth adjustment position.

FIG. 9 is a top sectional view of a frame wing according to an alternative embodiment, depicting an adjustment position, and depicting an alternative entry opening.

FIG. 10 is a top sectional view of a frame wing according to an alternative embodiment, depicting an adjustment position, and depicting an alternative entry opening.

FIG. 11 is perspective view of a depicting an alternative mounting position for a frame wing.

### DETAILED DESCRIPTION OF EXEMPLARY EMBODIMENTS

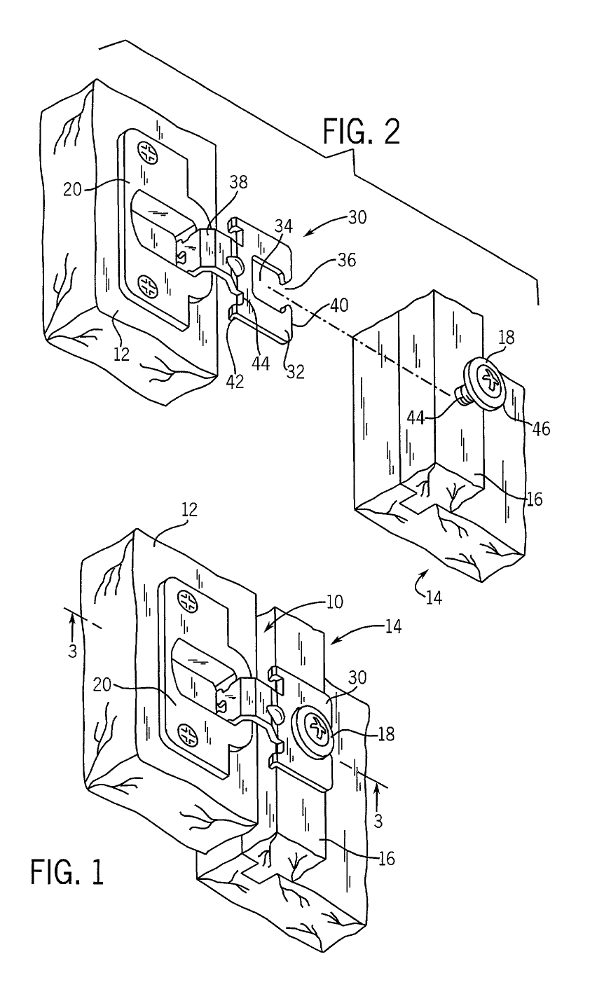

Referring to FIGS. 1-11, exemplary embodiments of a hinge for mounting a cabinet door to a cabinet frame are shown. It should be noted at the outset that the hinge can be used in any of a wide variety of cabinet doors and other doors, including concealed and unconcealed hinge arrangements known to those skilled in the art who may review the disclosure. Referring to FIG. 1, an exemplary embodiment of a hinge 10 is shown. Hinge 10 is used to mount a cabinet door or door stile for selective pivotal movement between an open position (depicted in FIG. 1) and a closed position with respect to a frame.

Hinge 10 includes a door wing 20 pivotally coupled to a frame wing 30. Door wing 20 is shown as a hinge cup type door wing, and is adapted to be mounted into and within a substantially cylindrical bore or recess in a door. The hinge cup may be adapted to fit into other bore geometries, not limited to substantially cylindrical. Frame wing 30 is adapted to be mounted to an edge 16 of frame 14 as depicted in FIG. 1. According to an exemplary embodiment, the hinge arrangement shown, having a hinge cup substantially embedded in a door, and having frame wing 30 mounted to an edge of frame 14, is an arrangement designed to conceal the hinge from view when viewed from the front of a cabinet. This arrangement is commonly known in the art as a “concealed” hinge.

Referring to FIG. 1, a hinge 10 is shown installed, connecting a door 12 to a frame 14. In the exemplary embodiment shown in FIG. 1, door 12 is a cabinet door, and frame 14 is a cabinet frame. As discussed above, hinge 10 includes door wing 20, and frame wing 30. Door wing 20 is mounted to door 12, and frame wing 30 is mounted to frame 14. Frame wing 30 may be mounted to frame 14 by a fastener 18 (shown as a washer head wood screw or a wood screw and washer combination). Alternatively, frame wing 30 may be mounted to frame 14 using a variety of other fasteners including machine screws such as #10×32 machine screws, other screws, nails, etc. Door wing 20 is pivotally coupled to frame wing 30, and thereby hinge 10 pivotally couples door 12 to frame 14, which allows door 12 and frame 14 to articulate with respect to each other.

As depicted in FIG. 2, frame wing 30 further includes plate 32, aperture 34, opening 36, and arm 38. Plate 32 is depicted as a substantially flat member but is not limited to substantially flat. In an exemplary embodiment, plate 32 has a width roughly corresponding to the width of frame edge 16, but may be of other widths. Plate 32 may be constructed from steel, steel alloys, other metals and metal alloys, etc.

Aperture 34 is disposed substantially within plate 32. In an exemplary embodiment depicted in FIG. 2, aperture 34 is disposed in an approximate center of plate 32. In a particularly preferred embodiment, aperture 34 has a width dimension which is at least twice as wide as a shaft 44 of fastener 18, and aperture 34 has a length dimension which is at least twice as wide as a shaft 44 of fastener 18. Aperture 34 may be rectangular or square in shape. Alternatively, aperture 34 may be any size and geometry which allows frame wing 30 to be properly adjusted on edge 16, as will be explained in further detail below. For example, the aperture may have a width and length dimension one and one-half times as wide as a shaft of a fastener, or the aperture may have a first and second dimension three times as wide as a shaft of a fastener. Furthermore, the shape of the aperture may be circular, triangular, etc.

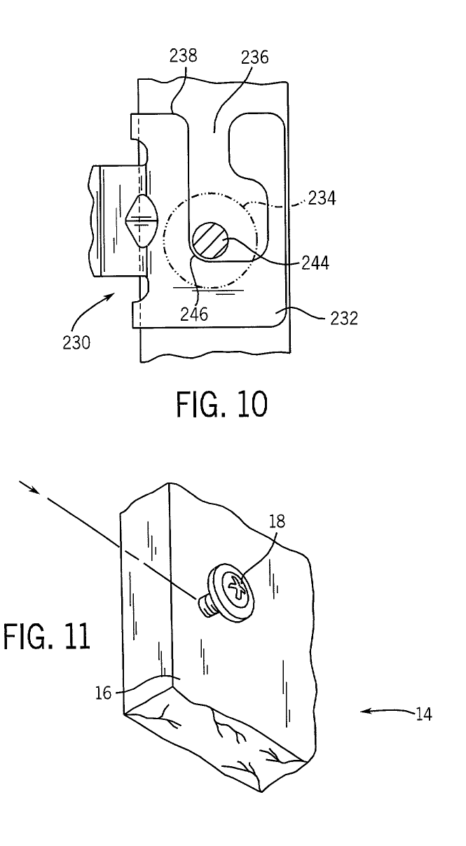

Opening 36 is shown disposed on a first edge 40 (shown as a front edge) of plate 32. Opening 36 may abut, or be connected to aperture 34. Alternatively, opening 36 may be considered to be formed as part of aperture 34. Opening 36 forms a break in an exterior perimeter of plate 32. As will be discussed in further detail below, opening 36 is configured to allow passage of shaft 44 of fastener 18 from a first position, exterior to plate 32, to a second position, interior to plate 32 (i.e. shaft 44 is within aperture 34). Allowing passage of fastener 18 into aperture 34 may be desirable when fastener 18 is preinstalled into frame 14, and door 12, with preinstalled hinge 10, needs to be coupled to frame 14. In an exemplary embodiment, opening 36 is substantially centered relative to aperture 34. However, the opening may be disposed off-center relative to the aperture. For example, FIG. 9 shows opening 136 disposed to one side of aperture 134. The alignment of the opening with respect to the aperture may be made when a certain application of the hinge requires adjustment to one side. For example, frame wing 130 may be used in applications where the hinge will hang onto fastener 134 before it is fully tightened down. Once fastener 134 enters opening 136, frame wing 130 may be hung from fastener 134 as shaft 144 moves into and is retained by corner 146 such that shaft 144 will not unintentionally slide out of opening 136, while hanging frame 130 (and the corresponding hinge (not shown)). Alternatively, the opening may be provided on other edges of the plate. For example, as shown in FIG. 10, frame wing 230 may have opening 236 provided on a side edge 238 of plate 232. Frame wing 230 may also be used in applications where the hinge will hang onto fastener 234 before it is fully tightened down. Once fastener 234 enters opening 236, frame wing 230 may be hung from fastener 234 as shaft 244 moves into and is retained by corner 246 such that shaft 244 will not unintentionally slide out of opening 236, while hanging frame 230 (and the corresponding hinge (not shown)).

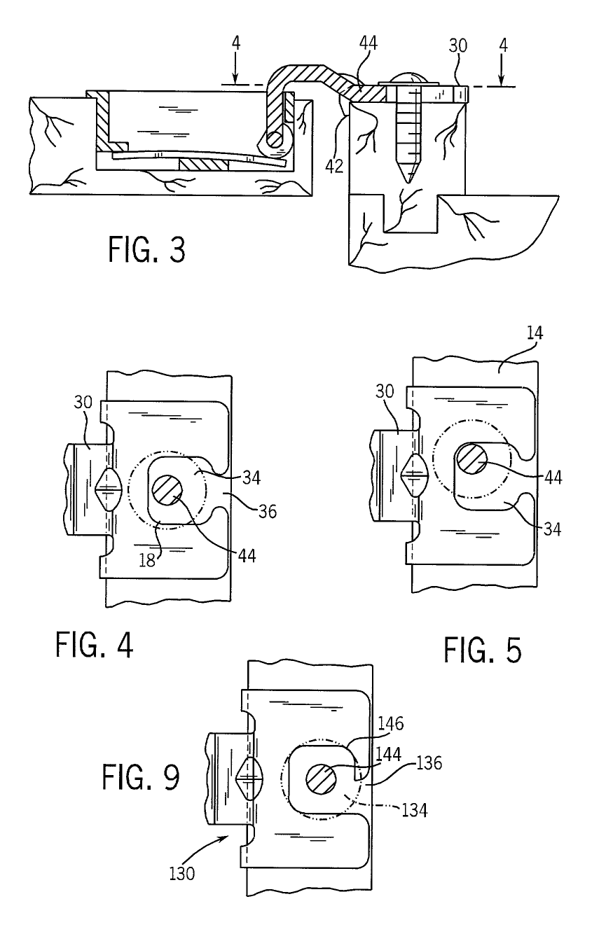

Referring to FIGS. 2 and 3, frame wing 30 may further include tabs 42. Tabs 42 project off plate 32 in a direction perpendicular to the surface of plate 32. As depicted in FIG. 2, tabs 42 are disposed on a second edge 44 of plate 32, on an opposing side of first edge 40. Tabs 42 may be used as a stop, such that when hinge 10 is slid onto frame 14, tabs 42 abut frame edge 16 and act as an initial positioning reference (see FIGS. 4-9).

The method of installing and adjusting hinge 10 to couple door 12 and frame 14 will now be discussed with reference to FIGS. 2-8. As discussed above, FIG. 2 depicts hinge 10 installed into door 12, and prior to installation onto frame 14. This may be a common situation facing an installer, for example, assembling cabinet doors to cabinet frames. Door 12 may have hinge 10 pre-installed, and an installer may then have to assemble hinge 10 and door 12 onto frame 14.

As depicted in FIG. 2, fastener 18 is preinstalled into edge 16 of frame 14. It may be desirable to preinstall fastener 18 in a predetermined location prior to attaching door 12 onto frame 14. Fastener 18 may be preinstalled in edge 16 of frame 14 in order to place fastener 18 in a more accurate position with respect to frame 14. Alternatively, as shown in FIG. 11, fastener 18 may be preinstalled directly into a side of the frame 14 with a variety of inserts. Once fastener 18 has been installed, hinge 10 (via frame wing 30) may be partially assembled onto frame 14. Frame wing 30 is partially assembled onto frame 14 by passing shaft 44 of fastener 18 through opening 36. Shaft 44 of fastener 18 then passes into aperture 34 of plate 32. A head 46 of fastener 18 loosely holds plate 32 with respect to frame 14. Head 46 is large enough such that in a variety of positions, as will be described below, frame wing 30 will not disengage from fastener 18 by pulling out through aperture 34. Using an opening, such as but not limited to opening 36, allows for rapid assembly of door 12 to frame 14 in a manufacturing environment or in an installation environment. Such an opening allows an increase in assembling efficiency. Further, when opening 36 is combined with aperture 34, assembling efficiency is further enhanced.

Once frame wing 30 has been partially assembled onto frame 14, hinge 10 and door 12 may be adjusted relative to frame 14 as shown in FIGS. 4-8. As depicted in FIG. 4, once shaft 44 of fastener 18 has passed through opening 36, shaft 44 is partially bounded within aperture 34. The only area shaft 44 is not bounded is the area adjacent to opening 36. In the partially assembled condition, frame wing 30 is free to move in any desired adjustment direction, including vertical adjustments, horizontal adjustments, or any combination thereof as shown in FIGS. 4-8. Frame wing 30 may be adjusted in a vertical direction, and a horizontal direction, the limits of such adjustment is a border of aperture 34.

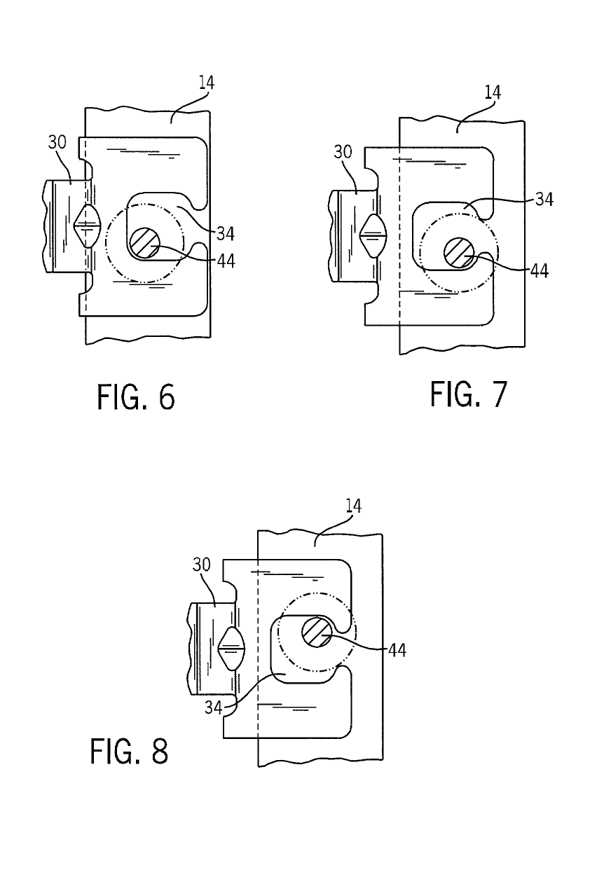

An advantageous feature of aperture 34 is allowing two-dimensional adjustment of frame wing 30. As depicted in FIG. 4, frame wing 30 is shown in a first adjustment position, with shaft 44 of fastener 18 in aperture 34, centered with respect to opening 36. As shown in FIG. 5, frame wing 30 is shown in a second adjustment position, with shaft 44 of fastener 18 in an upper left corner of aperture 34. This position would result in door 12 (not shown) being adjusted downward and inward with respect to frame 14. As shown in FIG. 6, frame wing 30 is shown in a third adjustment position, with shaft 44 of fastener 18 in a lower right corner of aperture 34. This position would result in door 12 (not shown) being adjusted upward and outward with respect to frame 14. As shown in FIG. 7, frame wing 30 is shown in a fourth adjustment position, with shaft 44 of fastener 18 in a lower left corner of aperture 34. This position would result in door 12 (not shown) being adjusted upward and inward with respect to frame 14. As shown in FIG. 8, frame wing 30 is shown in a fifth adjustment position, with shaft 44 of fastener 18 in an upper right corner of aperture 34. This position would result in door 12 (not shown) being adjusted downward and outward with respect to frame 14. It should be noted that the adjustment positions illustrated in FIGS. 4-8 are for illustrative purposes only. Frame wing 30 may be adjusted in a multitude of different positions within the boundary of aperture 34. This advantageously allows hinge 10 to compensate for errors or imprecise placement of fastener 18 in frame 14. Should an error be made in placement of fastener 18, hinge 10 may be able to compensate and still allow door 12 to be properly positioned with respect to frame 14 without repositioning fastener 18. Repositioning a fastener could result in damage to the frame, weakening of the frame material, aesthetic damage, or other such damage.

After frame wing 30 has been adjusted to a suitable position (and correspondingly, hinge 10 and door 12 have been adjusted) with respect to frame 14, fastener 18 may be tightened such that head 46 bears down on plate 32, and securely fastens frame wing 30 to frame 14.

It is also important to note that the construction and arrangement of the elements of the hinge shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. Accordingly, all such modifications are intended to be included within the scope of the present invention as defined in the appended claims. The order or sequence of any process or method steps may be varied or resequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the preferred and other exemplary embodiments without departing from the scope of the present inventions as expressed in the appended claims.

What is claimed is:

1. A hinge comprising:
a door wing;
a frame wing pivotally coupled to the door wing, the frame wing having an aperture disposed in the frame wing;
the aperture having an opening disposed on a first edge of the frame wing, the opening configured to allow a shaft of a fastener to slidably fit in the opening and into the aperture;
wherein the frame wing may be adjusted in at least two directions with respect to a frame by moving the frame wing with respect to the fastener, such adjustment being bounded by the shaft of the fastener within the aperture.

2. The hinge of claim 1, further comprising at least one tab disposed on a second edge of the frame wing, the at least one tab extending substantially perpendicular to the frame wing.

3. The hinge of claim 1, wherein the aperture is substantially rectangular.

4. The hinge of claim 1, wherein the aperture has a first and second dimension, the aperture is at least twice as wide as the shaft of the fastener in the first dimension, and the aperture is at least twice as wide as the shaft of the fastener in the second dimension.

5. The hinge of claim 1, wherein the opening is disposed on a center of the first edge.

6. The hinge of claim 1, wherein the opening is disposed offset of a center of the first edge.

7. The hinge of claim 1, wherein the first edge is a front edge of the frame wing.

8. The hinge of claim 1, wherein the first edge is a side edge of the frame wing.

9. A frame wing configured to be pivotally coupled to a hinge wing, the frame wing comprising:
a plate having an aperture disposed in the plate;
an opening disposed on a first edge of the plate, extending from the aperture, the opening configured to slidably fit a fastener;
wherein the frame wing may be adjusted with respect to a frame by moving the frame wing with respect to the fastener, such adjustment being bounded by the shaft of the fastener within the aperture.

10. The frame wing of claim 9, further comprising at least one tab disposed on a second edge of the plate, the tab extending substantially perpendicular to the plate.

11. The frame wing of claim 9, wherein the aperture is substantially rectangular.

12. The frame wing of claim 9, wherein the aperture is dimensioned to be at least twice as wide as the fastener in a first dimension, and at least twice as wide as the fastener in a second dimension.

13. The frame wing of claim 9, wherein the opening is disposed on a center of the first edge.

14. The frame wing of claim 9, wherein the opening is disposed offset of a center of the first edge.

15. The hinge of claim 9, wherein the first edge is a front edge of the frame wing.

16. The hinge of claim 9, wherein the first edge is a side edge of the frame wing.

17. A method of adjustably mounting a door to a frame, the method comprising:
coupling a door wing to the door;
rotatably coupling a frame wing to the door wing;
partially securing a fastener having a shaft to the frame; and
coupling the frame wing to the frame, wherein coupling further comprises:
passing the fastener shaft through an opening in the frame wing into an adjustment aperture in the frame wing;
adjusting the position of the frame wing within the adjustment aperture in both a lateral and longitudinal direction; and
securing the fastener.

18. A hinge for coupling a door to a cabinet frame, the cabinet frame including a preinstalled fastener with a shaft and a head, comprising:
a door wing pivotally coupled to a frame wing, the frame wing having a hinge arm portion and a mounting portion, the mounting portion including an adjustment aperture, such that the adjustment aperture has a width, greater than the diameter of the shaft of the fastener, in at least two perpendicular directions, the adjustment aperture having an entry opening at least the width of the shaft of the fastener and extending between the adjustment aperture and an edge of the mounting portion.

19. The hinge of claim 18, further comprising at least one tab disposed on the mounting portion, the tab extending substantially perpendicular to the mounting portion.

20. The hinge of claim 18, wherein the adjustment aperture is substantially rectangular.

21. The hinge of claim 18, wherein the entry opening is disposed on a center of the mounting portion.

22. The hinge of claim 18, wherein the entry opening is disposed offset of a center of the mounting portion.

23. The hinge of claim 18, wherein the entry opening is disposed on a front edge of the frame wing.

24. The hinge of claim 18, wherein the entry opening is disposed on a side edge of the frame wing.
